(19) United States
(12) Patent Application Publication
(10) Pub. No.: US 2025/0130484 A1
(43) Pub. Date: Apr. 24, 2025

(54) FRONT-LIT ILLUMINATION MODULE

(71) Applicant: Meta Platforms Technologies, LLC, Menlo Park, CA (US)

(72) Inventors: Zhujun Shi, Redmond, WA (US); Guohua Wei, Redmond, WA (US); Michael Patrick Schaub, Redmond, WA (US)

(21) Appl. No.: 18/762,871

(22) Filed: Jul. 3, 2024

Related U.S. Application Data
(60) Provisional application No. 63/591,782, filed on Oct. 20, 2023.
(60) Provisional application No. 63/614,806, filed on Dec. 26, 2023.

(51) Int. Cl. G03B 21/00; G03B 21/20

(52) U.S. Cl. CPC G03B 21/006; G03B 21/2013; G03B 21/2033; G03B 21/2066; G03B 21/2073; G03B 21/208

(57) ABSTRACT

An illumination module includes a LCoS panel, a plurality of light sources configured to generate illuminating light, and a lightguide optically coupled via coupling optics to the plurality of light sources and adapted to direct the illuminating light to the LCoS panel, the lightguide being configured to transmit light of a first polarization state and reflect light of a second polarization state orthogonal to the first polarization state. The plurality of light sources may include a microLED array.

### CROSS-REFERENCE TO RELATED APPLICATIONS

This application claims the benefit of priority under 35 U.S.C. § 119 (e) of U.S. Provisional Application No. 63/591,782, filed Oct. 20, 2023, and U.S. Provisional Application No. 63/614,806, filed Dec. 26, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a cross-sectional schematic view of a front-lit illumination module according to some embodiments.

FIG. 2 shows exemplary spatial and angular intensity distribution targets for a front-lit illumination module according to some embodiments.

FIG. 3 is a schematic illustration of a microLED array for a front-lit illumination module according to certain embodiments.

FIG. 4 is a schematic illustration of a dual source front-lit illumination module according to various embodiments.

FIG. 5 depicts example light path configurations for the dual source front-lit illumination module of FIG. 4 according to some embodiments.

FIG. 6 is a schematic illustration of a folded lightguide according to some embodiments.

FIG. 7 shows the co-integration of a beam shaping element with a polarized lightguide according to particular embodiments.

FIG. 8 illustrates the impact of the beam shaping element of FIG. 7 on the angular profile of a light source according to some embodiments.

FIG. 9 is a schematic illustration of a front-lit illumination module having polarization recycling according to some embodiments.

FIG. 10 includes a description of a front-lit illumination module including a polarization-selective diffuser according to some embodiments.

FIG. 11 depicts example polarization-selective diffuser structures according to various embodiments.

FIG. 12 depicts example non-lightguide illumination architectures according to some embodiments.

FIG. 13 is an illustration of exemplary augmented-reality glasses that may be used in connection with embodiments of this disclosure.

FIG. 14 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices and headsets enable users to experience events, such as interactions with people in a computer-generated simulation of a three-dimensional world or viewing data superimposed on a real-world view. Superimposing information onto a field of view may be achieved through an optical head-mounted display (OHMD) or by using embedded wireless glasses with a transparent heads-up display (HUD) or augmented reality overlay. VR/AR eyewear devices and headsets may be used for a variety of purposes. Governments may use such devices for military training, medical professionals may use such devices to simulate surgery, and engineers may use such devices as design visualization aids.

Virtual reality and augmented reality devices and headsets typically include an optical system having a microdisplay and imaging optics. Display light may be generated and projected to the eyes of a user using a display system where the light is in-coupled into a waveguide, transported therethrough by total internal reflection (TIR), replicated to form an expanded field of view, and out-coupled when reaching the position of a viewer's eye.

The microdisplay may be configured to provide an image to be viewed either directly or indirectly using, for example, a micro OLED display or by illuminating a liquid-crystal based display such as a liquid crystal on silicon (LCoS) microdisplay. Liquid crystal on silicon is a miniaturized reflective or transmissive active-matrix display having a liquid crystal layer disposed over a silicon backplane. During operation, light from a light source is directed at the liquid crystal layer and as the local orientation of the liquid crystals is modulated by a pixel-specific applied voltage, the phase retardation of the incident wavefront can be controlled to generate an image from the reflected or transmitted light. In some instantiations, a liquid crystal on silicon display may be referred to as a spatial light modulator.

LCoS-based projectors typically use three LCoS chips, one each to modulate light in the red, green, and blue channels. A LCoS projector may be configured to deliver the red, green, and blue components of image light simultaneously, which may result in a projected image having rich and well-saturated colors. A LCoS display may be configured for wavelength selective switching, structured illumination, optical pulse shaping, in addition to near-eye displays. As will be appreciated, reference herein to LCoS displays or LCoS technology includes reference to ferroelectric liquid crystal on silicon (FLCoS) displays and associated technology.

LCoS display technology commonly uses one or more polarizing beam splitters (PBS) for illumination, which may result in a relatively large form factor. One design approach to overcome this drawback is to use a front-lit illumination module with a polarized lightguide. However, notwithstanding the adoption of this configuration, achieving high efficiency and brightness remains a major challenge.

Disclosed are system architectures and related methods to achieve commercially-relevant performance (e.g., efficiency and uniformity) in front-lit illumination lightguides without compromising form factor. Example embodiments include light source and coupling optics engineering, efficient lightguide designs, and the introduction of polarization-selective components.

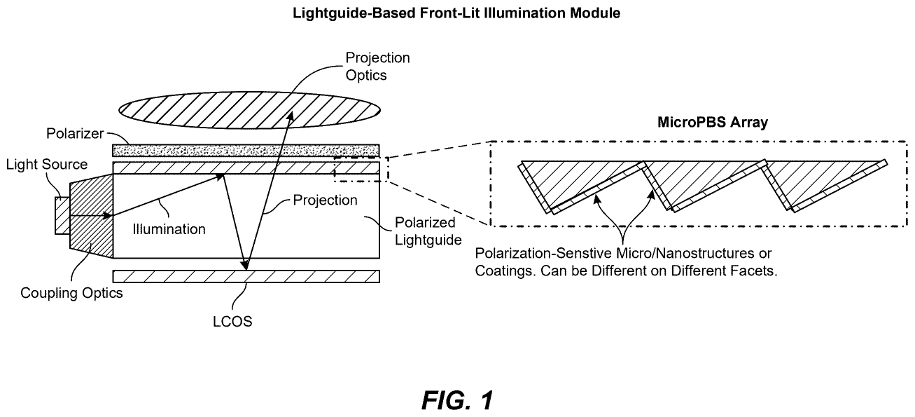

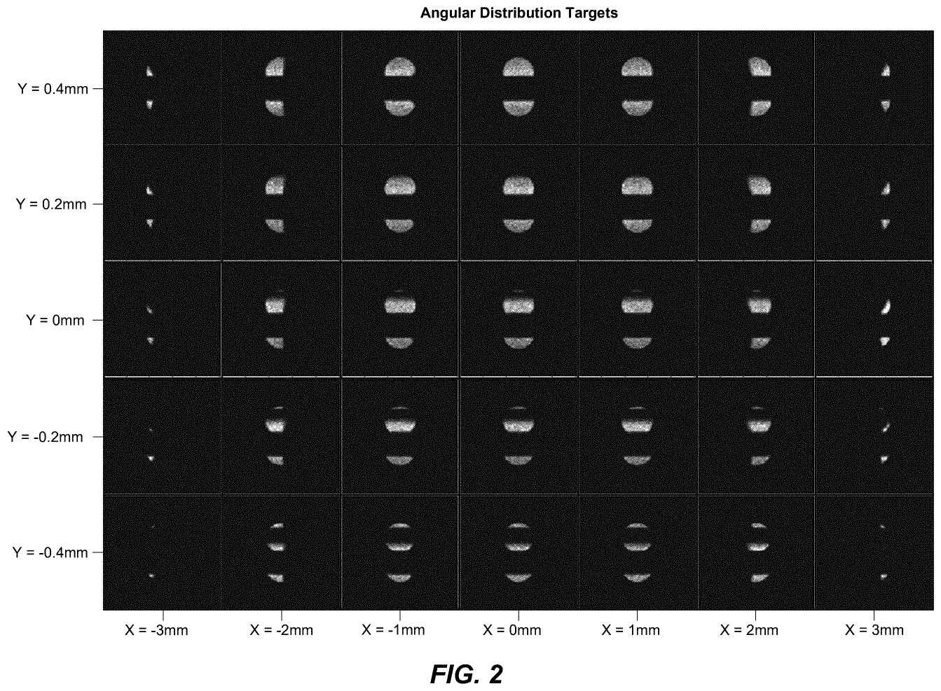

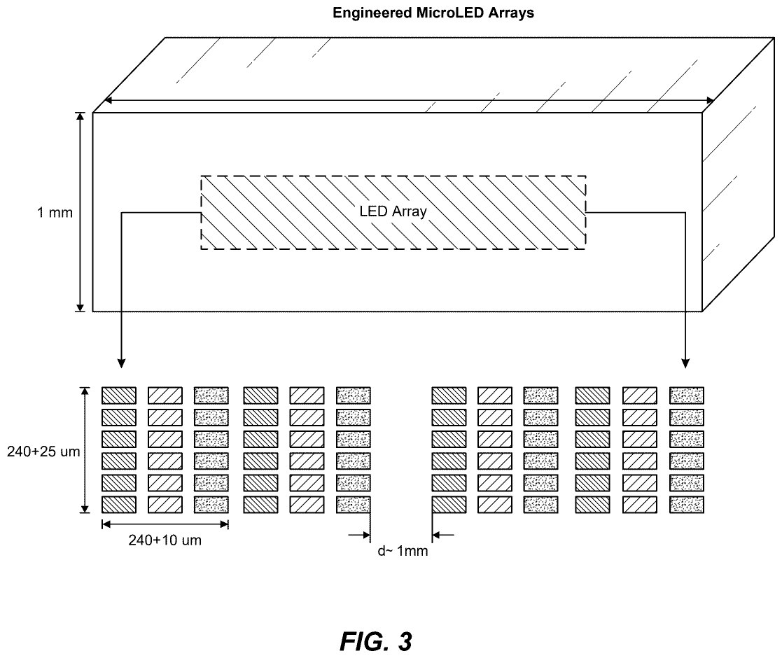

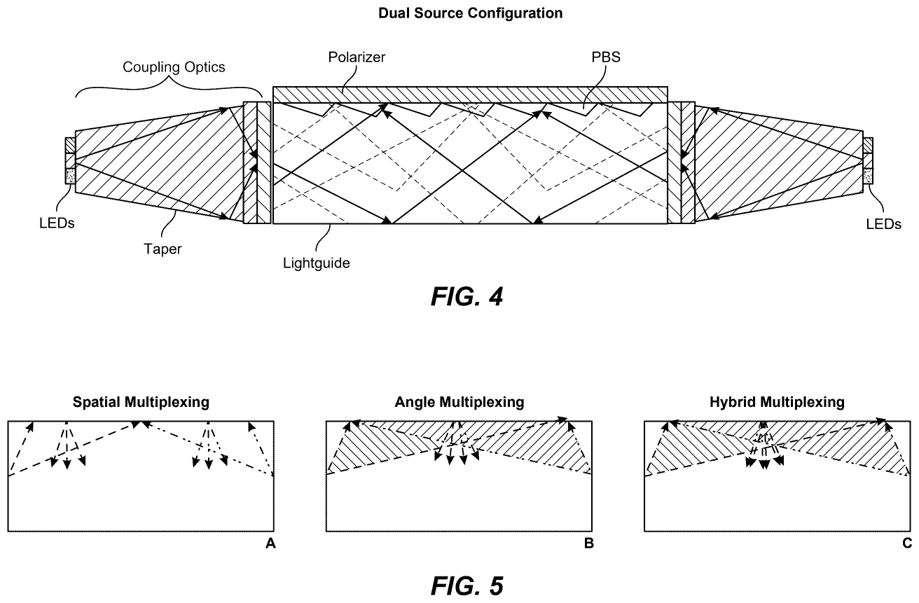

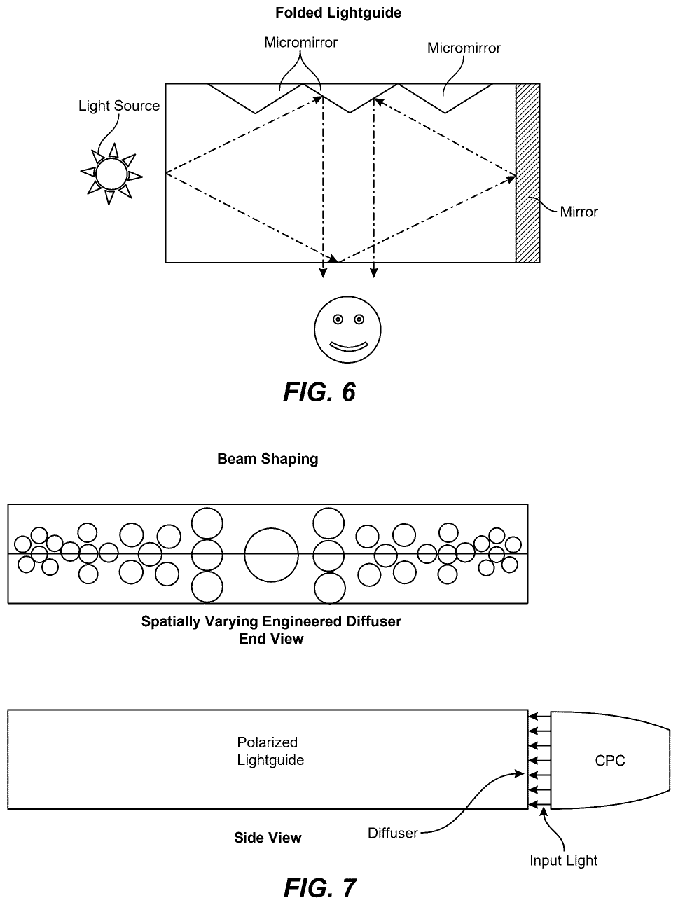

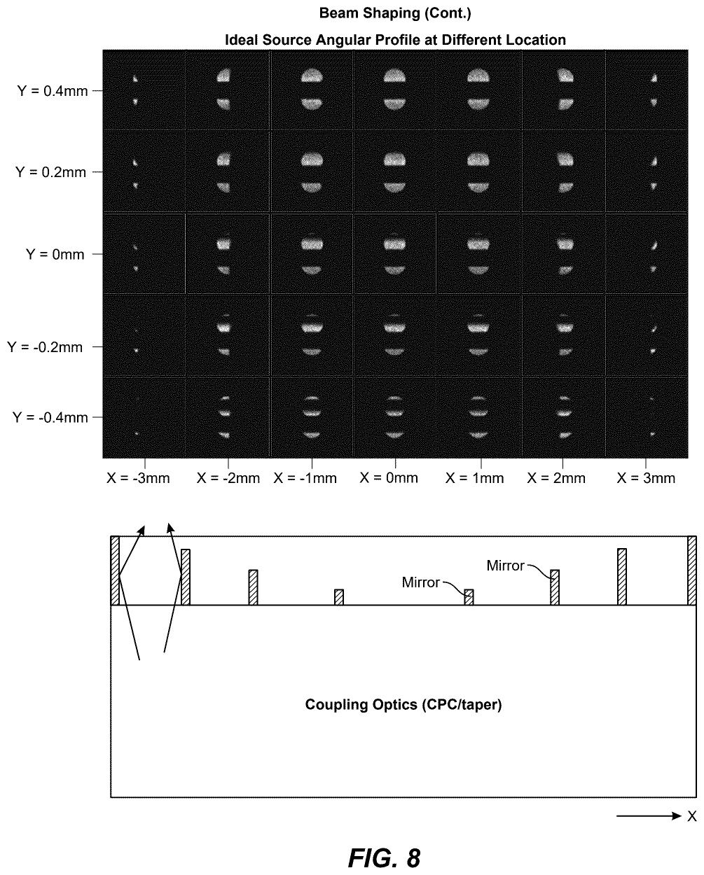

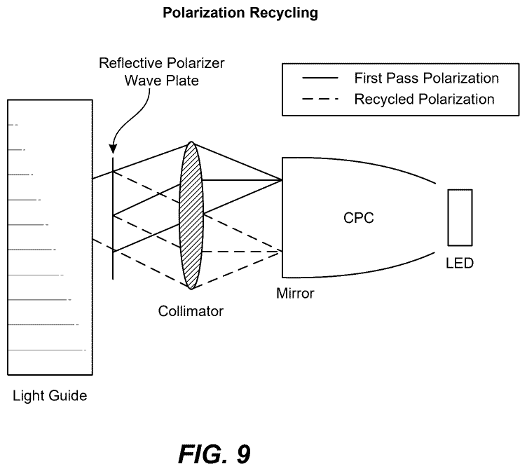

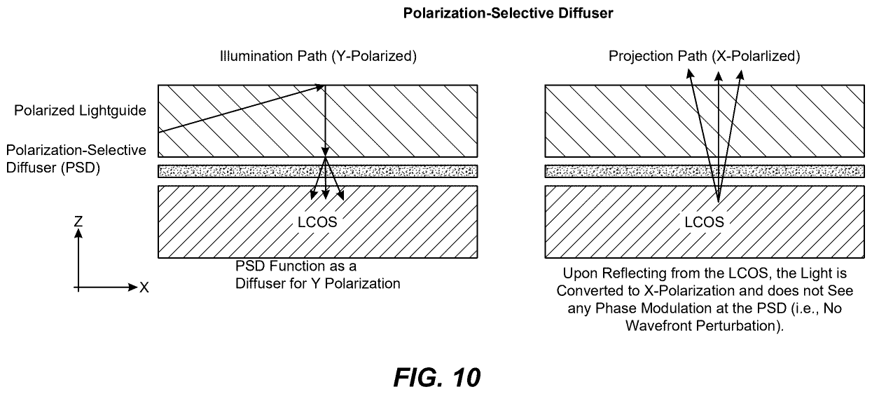

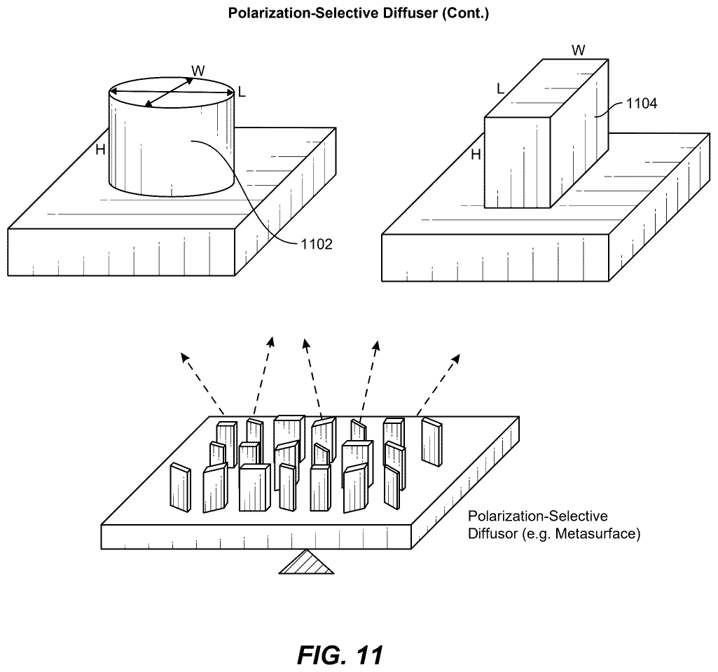

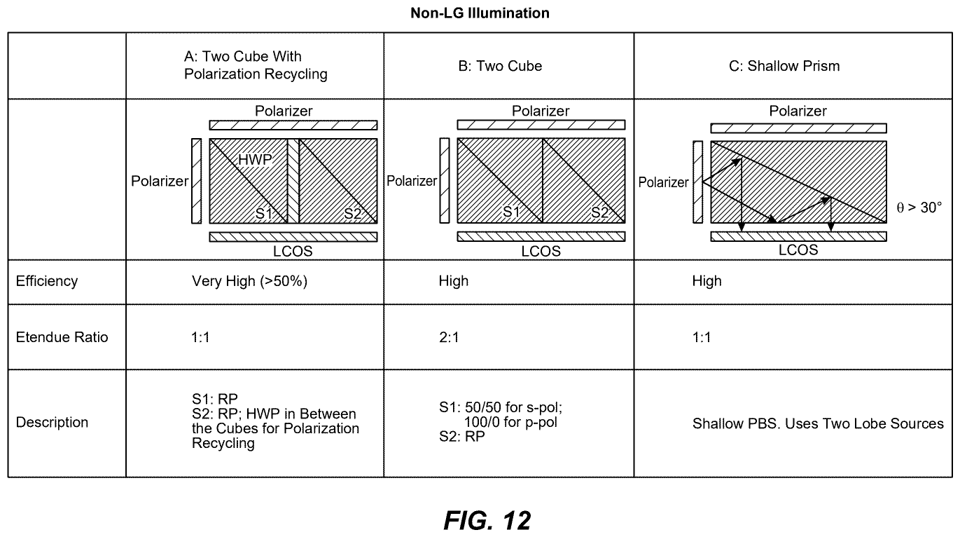

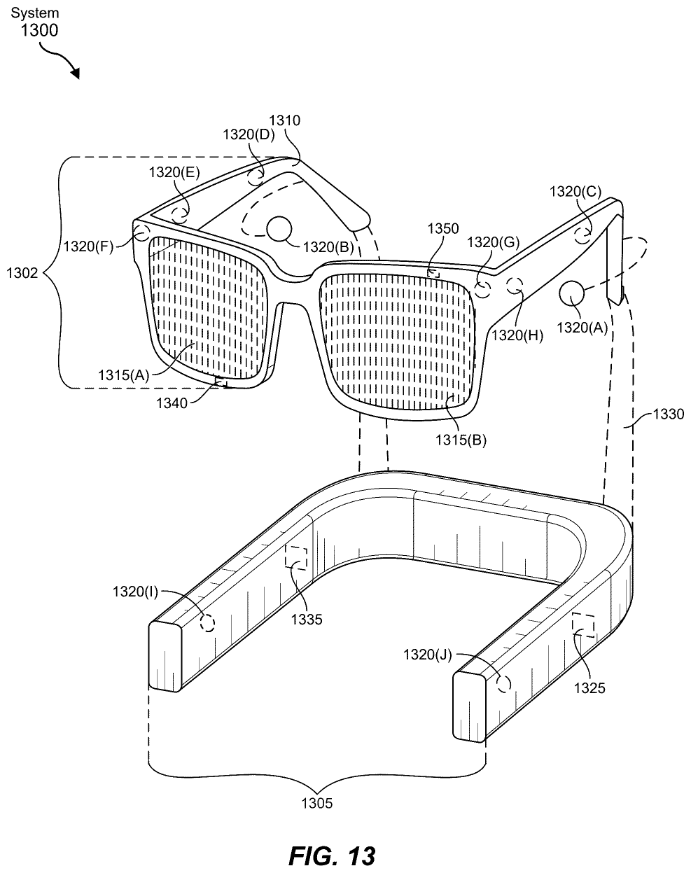

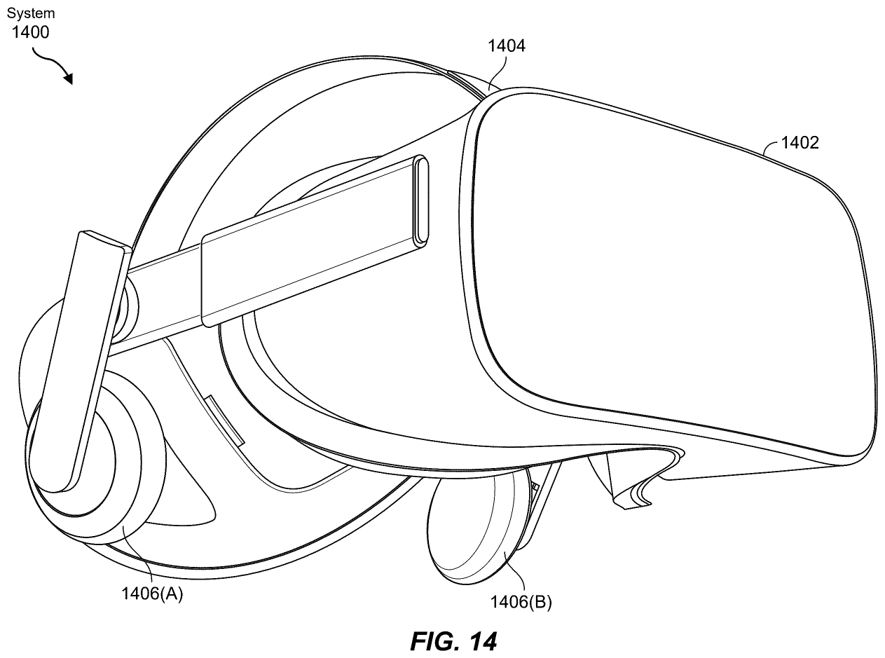

The following will provide, with reference to FIGS. 1-14, detailed descriptions of devices and related methods associated with a light engine including a front-lit illumination module. The discussion associated with FIG. 1 includes a description of a front-lit illumination module architecture and its method of operation. The discussion associated with FIG. 2 includes a description of the spatial and angular intensity distribution targets for a front-lit illumination module. The discussion associated with FIG. 3 includes a description of a microLED light source for a front-lit illumination module. The discussion associated with FIGS. 4 and 5 includes a description of a front-lit illumination module having a dual source configuration. The discussion associated with FIG. 6 includes a description of a folded lightguide. The discussion associated with FIGS. 7 and 8 includes a description of a front-lit illumination module having a beam-shaping diffuser. The discussion associated with FIG. 9 includes a description of a front-lit illumination module that is configured for polarization recycling. The discussion associated with FIGS. 10 and 11 includes a description of a front-lit illumination module including a polarization-selective diffuser. The discussion associated with FIG. 12 includes a description of non-lightguide illumination configurations. The discussion associated with FIGS. 13 and 14 relates to exemplary virtual reality and augmented reality devices that may include one or more front-lit illumination modules as disclosed herein.

A front-lit illumination module may be incorporated into the LCoS projector of an augmented reality (AR) display. Turning to FIG. 1, a front-lit illumination module includes a light source, coupling optics, and a polarized lightguide. The coupling optics are configured to couple output from the light source into the polarized lightguide. The polarized lightguide is arranged to direct in-coupled light to a LCoS panel with prescribed polarization selectivity and then direct the light that is modulated by the LCoS panel to the projection optics.

The polarization lightguide may include polarization-sensitive elements/materials, such as microscale or nanoscale structures or coatings, and is configured to interact with light propagating along both an illumination path and a projection path. That is, the polarization lightguide may be configured to reflect light having one polarization and transmit light having a complementary polarization. As shown in the inset, and by way of example, the polarized lightguide may include a micromirror array with polarization structures or coatings formed over a faceted surface. During operation, source light is injected into the polarized lightguide where it interacts with the micromirror and is directed to the LCoS panel where it is modulated and re-directed through the micromirror to a polarizer and the projection optics.

Performance attributes for a front-lit illumination module include efficiency, brightness, and uniformity. Adequate system performance for these benchmarks collectively remains a challenge. By way of illustration, and with reference to FIG. 2, to achieve uniform illumination on the LCoS, an ideal input beam profile to the lightguide may be characterized by a predetermined spatial and angular distribution, where disparity between actual and ideal beam profiles may lead to a significant loss of efficiency. As used herein, efficiency may be derived from a ratio of an amount of optical power collected to an amount of optical power provided.

In addition to the system efficiency, the required source brightness may be determined by the required optical power and the source area. Brightness may be related to the size of the light source and its achievable output, which may be limited by a maximum driving current. The use of micromirrors may support a smaller source area, for example, which results in a greater source brightness being needed for a given output brightness. As will be appreciated, this poses challenges to the source driving conditions, and may limit the achievable projector brightness. Finally, color-sequential operation requires spatial mixing of RGB light. Non-ideal color mixing may lead to nonuniformity issues.

As will be appreciated, larger LEDs are typically characterized by a fixed output profile, and may not possess the requisite spatial and angular distribution. According to some embodiments, the light source for a front-lit illumination module may include an array of microLEDs as an alternative to miniLEDs. An example microLED array is shown in FIG. 3. With microLEDs, engineering the size and shape of the source may be simplified, which may lead to improved coupling into the lightguide as well as improved color uniformity and better etendue matching and thus greater efficiency.

Referring to FIG. 4, according to further embodiments, a front-lit illumination module may include a pair of light sources. A light source may be located on each side of the lightguide, which may improve illumination efficiency, brightness, and uniformity. Such double-sided injection supports larger area sources and may simplify the input source beam profile, which increases coupling efficiency and improves brightness.

Design options and related principles of operation associated with a dual light source are shown in FIG. 5. An example spatial multiplexing configuration where light from the two sources illuminates different regions of the lightguide each with a full cone angle is shown in FIG. 5A. An example angular multiplexing configuration where light from the two sources illuminates an overlapping area of the lightguide with each source providing a partial cone angle is shown in FIG. 5B. A hybrid multiplexing configuration is shown in FIG. 5C, where light from the two sources illuminates an overlapping area of the lightguide with each source providing a full cone angle. In conjunction with the embodiment of FIG. 5C, a larger source area may be used, which advantageously decreases the source brightness requirement.

In some embodiments, a lightguide may include a reflective element configured to direct at least a portion of propagating light onto a micro-mirror array, which is configured to outcouple and direct the light to a user's eyes. Such a folded lightguide, which is depicted in FIG. 6, may be characterized by a decreased footprint and overall decreased complexity.

As illustrated in FIG. 6, light from a light source is coupled into the lightguide and propagates therethrough by total internal reflection. A first portion of the light may interact with a micromirror array. The first portion of the light may be directed out of the lightguide and toward the eyes of a user. A second portion of the light may propagate by total internal reflection beyond the micromirror array. The second portion of the light may interact with a reflective element, such as a mirror, that directs the light back to the micromirror array and thereafter to the eyes of a user. The implementation of the mirror may effectively create a virtual dual source illumination module.

Referring to FIG. 7, shown is a portion of a front-lit illumination module where a spatially varying diffuser is disposed over an input face of the lightguide (between the lightguide and the output face of an adjoining compound parabolic concentrator (CPC) or taper). Input light from a source (not shown) may be directed to the diffuser/polarized lightguide through the CPC or taper. The diffuser may include engineered plural regions with structures such as microlenses or diffractive features having high dispersion. The diffuser may be configured to generate in the polarized lightguide a desired spatial and angular distribution of light.

Turning to FIG. 8, a plurality of mirrors may be incorporated into the coupling optics to shape a desired angular profile of input light as a function of position. A plurality of mirrors may be arrayed along one or two dimensions. Because the desired angular profile of input light varies across the input face of the lightguide, individual mirrors may be independently sized and shaped. By way of example, in FIG. 8, plural mirrors are arrayed along an x direction where the mirror length changes as a function of position, with shorter mirrors located in the central region of the array. In some embodiments, mirrors may be located within the extender section of the CPC/coupling optics. Shown also in FIG. 8 is an angular profile of light downstream of the mirrors as a function of position.

Referring to FIG. 9, a front-lit illumination module may include a polarization recycling capability. Together with a collimator, a reflective polarizer and waveplate may be disposed between a mirrored CPC and a lightguide, and may be configured to direct mutually orthogonal polarizations of source light to the lightguide.

According to further embodiments, a polarization-selective diffuser (PSD) may be co-integrated with a front-lit illumination module and may beneficially improve illumination efficiency, uniformity, and contrast. As shown in FIG. 10, a PSD may be configured to increase the cone angle of light illuminating the LCoS while preserving the wavefront within the projection path.

A polarization-selective diffuser may include a birefringent material and/or may be structured as a polarization-selective grating, such as a volume Bragg grating (VBG) or a polarization volume hologram (PVH), or may include a nanostructured surface, such as a metasurface.

Example polarization-selective metasurface architectures are illustrated in FIG. 11. Nanopillars 1102, 1104 may be suitably shaped and dimensioned to control their interaction with incident light. For instance, a metasurface array may be configured to function as a microlens array (MLA) for one polarization of incident light and to impart a uniform phase profile to the complementary polarization. In such a manner, and with reference again to FIG. 10, the PSD may operate as a diffuser in the illumination path while being effectively transparent in the projection path.

Referring to FIG. 12, depicted schematically are alternative illumination architectures to the previously-disclosed lightguide-based modules. In the structures of FIG. 12, a PBS array has been substituted by a pair of reflective elements or a single reflective element. The resulting architectures may have an economically-viable form factor.

Depicted in FIG. 12A is a dual PBS architecture where the pair of optical elements are separated by a halfwave plate (HWP). During operation, input light may initially interact with element S1, which in the illustrated embodiment may be a reflective polarizer (RP). The reflective polarizer is configured to reflect light having a first polarization and transmit light having a second, orthogonal polarization. The transmitted light interacts with the halfwave plate and is converted to the first polarization and is thereafter reflected by element S2. The dual PBS architecture of FIG. 12A may have an economically-attractive footprint and may provide improved efficiency through polarization recycling.

Referring to FIG. 12B, the module architecture of FIG. 12A is repeated but without the halfwave plate located between the first and second elements, S1 and S2. In an example configuration, S1 may be a 50-50 polarizer for a first polarization of light (e.g., s-polarized light) and a 100-0 polarizer for a second, orthogonal polarization of light (e.g., p-polarized light). In such a manner, incident light will be reflected to the LCoS by either element S1 or element S2.

Referring to FIG. 12C, the illuminator module includes a single, shallow prism, which may be oriented at an angle of approximately 30° or greater. Light incident upon the module may be directed by the reflector to the LCoS with or without a TIR event.

Disclosed are lightguide-based front-lit illumination modules. The front-lit illumination modules may be incorporated into a LCoS light engine, for example. Various aspects of the illumination modules, including the design and integration of the light source, coupling optics, and polarization lightguide design, as well as the co-integration of a polarization-selective component, may be implemented independently or in combination to achieve efficient and uniform operation of a display.

### Example Embodiments

Example 1: An illumination module includes a LCoS panel, a plurality of light sources configured to generate illuminating light, and a lightguide optically coupled via coupling optics to the plurality of light sources and adapted to direct the illuminating light to the LCoS panel, the lightguide being configured to transmit light of a first polarization state and reflect light of a second polarization state orthogonal to the first polarization state.

Example 2: The illumination module of Example 1, where the coupling optics include an optical concentrator.

Example 3: The illumination module of Example 1 or 2, where the coupling optics have a tapered cross-sectional shape.

Example 4: The illumination module of any of Examples 1-3, where the plurality of light sources include a microLED array.

Example 5: The illumination module of any of Examples 1-4, where the plurality of light sources include a first microLED array disposed proximate to a first side of the lightguide and a second microLED array disposed proximate to a second side of the lightguide.

Example 6: The illumination module of any of Examples 1-5, where the lightguide includes a micromirror array.

Example 7: The illumination module of any of Examples 1-6, where the lightguide includes a polarization beam splitter.

Example 8: The illumination module of any of Examples 1-7, further including a spatially variable diffuser disposed between the coupling optics and the lightguide.

Example 9: The illumination module of any of Examples 1-8, further including a polarization recycling assembly disposed between the coupling optics and the lightguide.

Example 10: The illumination module of any of Examples 1-9, further including a polarization-selective diffuser disposed between the lightguide and the LCoS panel.

Example 11: An illumination module includes a light source configured to generate illuminating light, a lightguide optically coupled to the light source and configured to transmit light of a first polarization state and reflect light of a second polarization state orthogonal to the first polarization state, a LCoS panel located proximate to a first side of the lightguide, the LCoS panel configured to generate projection light from the illuminating light, and projection optics located proximate to a second side of the lightguide opposite to the first side, where the lightguide is adapted to direct the illuminating light to the LCoS panel and direct the projection light to the projection optics.

Example 12: The illumination module of Example 11, where the light source includes a microLED array.

Example 13: The illumination module of any of Examples 11 and 12, where the lightguide includes a micromirror array.

Example 14: The illumination module of any of Examples 11-13, further including a spatially variable diffuser disposed between the light source and the lightguide.

Example 15: The illumination module of any of Examples 11-14, further including a polarization recycling assembly disposed between the light source and the lightguide.

Example 16: The illumination module of any of Examples 11-15, further including a polarization-selective diffuser disposed between the lightguide and the LCoS panel.

Example 17: The illumination module of Example 16, where the polarization-selective diffuser includes a metasurface.

Example 18: An illumination module includes a light source configured to generate illuminating light, a polarization beam splitter optically coupled via coupling optics to the light source, a LCoS panel located proximate to a first side of the polarization beam splitter, the LCoS panel configured to generate projection light from the illuminating light, and projection optics located proximate to a second side of the lightguide opposite to the first side, where the polarization beam splitter is adapted to direct the illuminating light to LCoS panel and direct the projection light to the projection optics.

Example 19: The illumination module of Example 18, where the polarization beam splitter includes a reflective polarizer.

Example 20: The illumination module of any of Examples 18 and 19, where the coupling optics includes a polarizer.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 1300 in FIG. 13) or that visually immerses a user in an artificial reality (e.g., virtual-reality system 1400 in FIG. 14). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 13, augmented-reality system 1300 may include an eyewear device 1302 with a frame 1310 configured to hold a left display device 1315(A) and a right display device 1315(B) in front of a user's eyes. Display devices 1315(A) and 1315(B) may act together or independently to present an image or series of images to a user. While augmented-reality system 1300 includes two displays, embodiments of this disclosure may be implemented in augmented-reality systems with a single NED or more than two NEDs.

In some embodiments, augmented-reality system 1300 may include one or more sensors, such as sensor 1340. Sensor 1340 may generate measurement signals in response to motion of augmented-reality system 1300 and may be located on substantially any portion of frame 1310. Sensor 1340 may represent a position sensor, an inertial measurement unit (IMU), a depth camera assembly, a structured light emitter and/or detector, or any combination thereof. In some embodiments, augmented-reality system 1300 may or may not include sensor 1340 or may include more than one sensor. In embodiments in which sensor 1340 includes an IMU, the IMU may generate calibration data based on measurement signals from sensor 1340. Examples of sensor 1340 may include, without limitation, accelerometers, gyroscopes, magnetometers, other suitable types of sensors that detect motion, sensors used for error correction of the IMU, or some combination thereof.

Augmented-reality system 1300 may also include a microphone array with a plurality of acoustic transducers 1320(A)-1320(J), referred to collectively as acoustic transducers 1320. Acoustic transducers 1320 may be transducers that detect air pressure variations induced by sound waves. Each acoustic transducer 1320 may be configured to detect sound and convert the detected sound into an electronic format (e.g., an analog or digital format). The microphone array in FIG. 13 may include, for example, ten acoustic transducers: 1320(A) and 1320(B), which may be designed to be placed inside a corresponding ear of the user, acoustic transducers 1320(C), 1320(D), 1320(E), 1320(F), 1320(G), and 1320(H), which may be positioned at various locations on frame 1310, and/or acoustic transducers 1320(I) and 1320(J), which may be positioned on a corresponding neckband 1305.

In some embodiments, one or more of acoustic transducers 1320(A)-(F) may be used as output transducers (e.g., speakers). For example, acoustic transducers 1320(A) and/or 1320(B) may be earbuds or any other suitable type of headphone or speaker.

The configuration of acoustic transducers 1320 of the microphone array may vary. While augmented-reality system 1300 is shown in FIG. 13 as having ten acoustic transducers 1320, the number of acoustic transducers 1320 may be greater or less than ten. In some embodiments, using higher numbers of acoustic transducers 1320 may increase the amount of audio information collected and/or the sensitivity and accuracy of the audio information. In contrast, using a lower number of acoustic transducers 1320 may decrease the computing power required by an associated controller 1350 to process the collected audio information. In addition, the position of each acoustic transducer 1320 of the microphone array may vary. For example, the position of an acoustic transducer 1320 may include a defined position on the user, a defined coordinate on frame 1310, an orientation associated with each acoustic transducer 1320, or some combination thereof.

Acoustic transducers 1320(A) and 1320(B) may be positioned on different parts of the user's ear, such as behind the pinna, behind the tragus, and/or within the auricle or fossa. Or, there may be additional acoustic transducers 1320 on or surrounding the ear in addition to acoustic transducers 1320 inside the ear canal. Having an acoustic transducer 1320 positioned next to an ear canal of a user may enable the microphone array to collect information on how sounds arrive at the ear canal. By positioning at least two of acoustic transducers 1320 on either side of a user's head (e.g., as binaural microphones), augmented-reality device 1300 may simulate binaural hearing and capture a 3D stereo sound field around about a user's head. In some embodiments, acoustic transducers 1320(A) and 1320(B) may be connected to augmented-reality system 1300 via a wired connection 1330, and in other embodiments acoustic transducers 1320(A) and 1320(B) may be connected to augmented-reality system 1300 via a wireless connection (e.g., a Bluetooth connection). In still other embodiments, acoustic transducers 1320(A) and 1320(B) may not be used at all in conjunction with augmented-reality system 1300.

Acoustic transducers 1320 on frame 1310 may be positioned along the length of the temples, across the bridge, above or below display devices 1315(A) and 1315(B), or some combination thereof. Acoustic transducers 1320 may be oriented such that the microphone array is able to detect sounds in a wide range of directions surrounding the user wearing the augmented-reality system 1300. In some embodiments, an optimization process may be performed during manufacturing of augmented-reality system 1300 to determine relative positioning of each acoustic transducer 1320 in the microphone array.

In some examples, augmented-reality system 1300 may include or be connected to an external device (e.g., a paired device), such as neckband 1305. Neckband 1305 generally represents any type or form of paired device. Thus, the following discussion of neckband 1305 may also apply to various other paired devices, such as charging cases, smart watches, smart phones, wrist bands, other wearable devices, hand-held controllers, tablet computers, laptop computers, other external compute devices, etc.

As shown, neckband 1305 may be coupled to eyewear device 1302 via one or more connectors. The connectors may be wired or wireless and may include electrical and/or non-electrical (e.g., structural) components. In some cases, eyewear device 1302 and neckband 1305 may operate independently without any wired or wireless connection between them. While FIG. 13 illustrates the components of eyewear device 1302 and neckband 1305 in example locations on eyewear device 1302 and neckband 1305, the components may be located elsewhere and/or distributed differently on eyewear device 1302 and/or neckband 1305. In some embodiments, the components of eyewear device 1302 and neckband 1305 may be located on one or more additional peripheral devices paired with eyewear device 1302, neckband 1305, or some combination thereof.

Pairing external devices, such as neckband 1305, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1300 may be provided by a paired device or shared between a paired device and an eyewear device, thus reducing the weight, heat profile, and form factor of the eyewear device overall while still retaining desired functionality. For example, neckband 1305 may allow components that would otherwise be included on an eyewear device to be included in neckband 1305 since users may tolerate a heavier weight load on their shoulders than they would tolerate on their heads. Neckband 1305 may also have a larger surface area over which to diffuse and disperse heat to the ambient environment. Thus, neckband 1305 may allow for greater battery and computation capacity than might otherwise have been possible on a stand-alone eyewear device. Since weight carried in neckband 1305 may be less invasive to a user than weight carried in eyewear device 1302, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1305 may be communicatively coupled with eyewear device 1302 and/or to other devices. These other devices may provide certain functions (e.g., tracking, localizing, depth mapping, processing, storage, etc.) to augmented-reality system 1300. In the embodiment of FIG. 13, neckband 1305 may include two acoustic transducers (e.g., 1320(I) and 1320(J)) that are part of the microphone array (or potentially form their own microphone subarray). Neckband 1305 may also include a controller 1325 and a power source 1335.

Acoustic transducers 1320(I) and 1320(J) of neckband 1305 may be configured to detect sound and convert the detected sound into an electronic format (analog or digital). In the embodiment of FIG. 13, acoustic transducers 1320(I) and 1320(J) may be positioned on neckband 1305, thereby increasing the distance between the neckband acoustic transducers 1320(I) and 1320(J) and other acoustic transducers 1320 positioned on eyewear device 1302. In some cases, increasing the distance between acoustic transducers 1320 of the microphone array may improve the accuracy of beamforming performed via the microphone array. For example, if a sound is detected by acoustic transducers 1320(C) and 1320(D) and the distance between acoustic transducers 1320(C) and 1320(D) is greater than, e.g., the distance between acoustic transducers 1320(D) and 1320(E), the determined source location of the detected sound may be more accurate than if the sound had been detected by acoustic transducers 1320(D) and 1320(E).

Controller 1325 of neckband 1305 may process information generated by the sensors on neckband 1305 and/or augmented-reality system 1300. For example, controller 1325 may process information from the microphone array that describes sounds detected by the microphone array. For each detected sound, controller 1325 may perform a direction-of-arrival (DOA) estimation to estimate a direction from which the detected sound arrived at the microphone array. As the microphone array detects sounds, controller 1325 may populate an audio data set with the information. In embodiments in which augmented-reality system 1300 includes an inertial measurement unit, controller 1325 may compute all inertial and spatial calculations from the IMU located on eyewear device 1302. A connector may convey information between augmented-reality system 1300 and neckband 1305 and between augmented-reality system 1300 and controller 1325. The information may be in the form of optical data, electrical data, wireless data, or any other transmittable data form. Moving the processing of information generated by augmented-reality system 1300 to neckband 1305 may reduce weight and heat in eyewear device 1302, making it more comfortable to the user.

Power source 1335 in neckband 1305 may provide power to eyewear device 1302 and/or to neckband 1305. Power source 1335 may include, without limitation, lithium ion batteries, lithium-polymer batteries, primary lithium batteries, alkaline batteries, or any other form of power storage. In some cases, power source 1335 may be a wired power source. Including power source 1335 on neckband 1305 instead of on eyewear device 1302 may help better distribute the weight and heat generated by power source 1335.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1400 in FIG. 14, that mostly or completely covers a user's field of view. Virtual-reality system 1400 may include a front rigid body 1402 and a band 1404 shaped to fit around a user's head. Virtual-reality system 1400 may also include output audio transducers 1406(A) and 1406(B). Furthermore, while not shown in FIG. 14, front rigid body 1402 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 1300 and/or virtual-reality system 1400 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 1300 and/or virtual-reality system 1400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 1300 and/or virtual-reality system 1400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 14, output audio transducers 1406(A) and 1406(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 13, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50+5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes polycarbonate include embodiments where a lens consists essentially of polycarbonate and embodiments where a lens consists of polycarbonate.

What is claimed is:

1. An illumination module comprising:
a LCoS panel;
a plurality of light sources configured to generate illuminating light; and
a lightguide optically coupled via coupling optics to the plurality of light sources and adapted to direct the illuminating light to the LCoS panel, the lightguide being configured to transmit light of a first polarization state and reflect light of a second polarization state orthogonal to the first polarization state.

2. The illumination module of claim 1, wherein the coupling optics comprise an optical concentrator.

3. The illumination module of claim 1, wherein the coupling optics comprise a tapered cross-sectional shape.

4. The illumination module of claim 1, wherein the plurality of light sources comprise a microLED array.

5. The illumination module of claim 1, wherein the plurality of light sources comprise a first microLED array disposed proximate to a first side of the lightguide and a second microLED array disposed proximate to a second side of the lightguide.

6. The illumination module of claim 1, wherein the lightguide comprises a micromirror array.

7. The illumination module of claim 1, wherein the lightguide comprises a polarization beam splitter.

8. The illumination module of claim 1, further comprising a spatially variable diffuser disposed between the coupling optics and the lightguide.

9. The illumination module of claim 1, further comprising a polarization recycling assembly disposed between the coupling optics and the lightguide.

10. The illumination module of claim 1, further comprising a polarization-selective diffuser disposed between the lightguide and the LCoS panel.

11. An illumination module comprising:
a light source configured to generate illuminating light;
a lightguide optically coupled to the light source and configured to transmit light of a first polarization state and reflect light of a second polarization state orthogonal to the first polarization state;
a LCoS panel located proximate to a first side of the lightguide, the LCoS panel configured to generate projection light from the illuminating light; and
projection optics located proximate to a second side of the lightguide opposite to the first side, wherein the lightguide is adapted to direct the illuminating light to the LCoS panel and direct the projection light to the projection optics.

12. The illumination module of claim 11, wherein the light source comprises a microLED array.

13. The illumination module of claim 11, wherein the lightguide comprises a micromirror array.

14. The illumination module of claim 11, further comprising a spatially variable diffuser disposed between the light source and the lightguide.

15. The illumination module of claim 11, further comprising a polarization recycling assembly disposed between the light source and the lightguide.

16. The illumination module of claim 11, further comprising a polarization-selective diffuser disposed between the lightguide and the LCoS panel.

17. The illumination module of claim 16, wherein the polarization-selective diffuser comprises a metasurface.

18. An illumination module comprising:
a light source configured to generate illuminating light;
a polarization beam splitter optically coupled via coupling optics to the light source;
a LCoS panel located proximate to a first side of the polarization beam splitter, the LCoS panel configured to generate projection light from the illuminating light; and
projection optics located proximate to a second side of the lightguide opposite to the first side, wherein the polarization beam splitter is adapted to direct the illuminating light to LCoS panel and direct the projection light to the projection optics.

19. The illumination module of claim 18, wherein the polarization beam splitter comprises a reflective polarizer.

20. The illumination module of claim 18, wherein the coupling optics comprises a polarizer.
